(19) United States
(12) Patent Application Publication
(10) Pub. No.: US 2009/0248715 A1
(43) Pub. Date: Oct. 1, 2009

(54) OPTIMIZING HIERARCHICAL ATTRIBUTES FOR OLAP NAVIGATION

(75) Inventors: Gregory Bernhardt, Boise, ID (US); Craig Kenneth Boobar, Eagle, ID (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/059,714

(22) Filed: Mar. 31, 2008

(51) Int. Cl. G06F 17/30

(52) U.S. Cl. 707/100; 707/E17.056

(57) ABSTRACT

OLAP navigation is simplified by optimizing the displayed hierarchies. An OLAP navigation user interface displays the hierarchies that are navigable and can be drilled down into. In this way, a user is shown the items within the OLAP data that may be drilled down into instead of being shown every item. When determining the items to display for navigation, any hierarchies with a single level and/or any attributes that also are used as levels are not shown within the user interface. This helps the user choose the displayed item that will have be most capabilities for OLAP interaction. Navigation of the OLAP data is simplified for the user since the number of items displayed is reduced.

### BACKGROUND

Online analytical processing (OLAP) is an integral part of most data warehouse and business analysis systems. OLAP services provide for fast analysis of multidimensional information. For this purpose, OLAP services provide for multidimensional access and navigation of the data in an intuitive and natural way, providing a global view of data that can be “drilled down” into particular data of interest. In OLAP, information is viewed conceptually as cubes, consisting of hierarchies including dimensions, levels, attributes and measures. In this context, a dimension is a structural attribute of a cube that is a list of members of a similar type in the user's perception of the data. Typically, there are levels associated with each dimension. For example, a time dimension may have hierarchical levels consisting of days, weeks, months, and years, while a geography dimension may have levels of cities, states/provinces, and countries. Dimension members act as indices for identifying a particular cell or range of cells within a multidimensional array. Each cell contains a value, also referred to as a measure, or measurement.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

OLAP navigation is simplified by optimizing the displayed hierarchies. An OLAP navigation user interface displays the hierarchies that are navigable. In this way, a user is shown the items within the OLAP data that may be drilled down into instead of being shown every item. When determining the items to display for navigation, any hierarchies with a single level and/or any attributes that also are used as levels are not shown within the user interface. This helps the user choose the displayed item that will have the most capabilities for OLAP interaction. Navigation of the OLAP data is simplified for the user since the number of items displayed is reduced.

### BRIEF DESCRIPTION OF THE DRAWINGS

FIG. 1 illustrates an exemplary computing environment;

FIG. 2 illustrates an OLAP navigation system;

FIG. 3 illustrates an exemplary OLAP cube;

FIG. 4 shows an exemplary menu system for navigating OLAP data; and

FIG. 5 illustrates a process for optimizing the displayed hierarchies for navigation.

### DETAILED DESCRIPTION

Throughout the specification and claims, the following terms take the meanings associated herein, unless the context clearly dictates otherwise. The term “cube” refers to a set of data that is organized and summarized into a multidimensional structure defined by a set of dimensions and measures.

The term “dimension” refers to a structural attribute of a cube, which is an organized hierarchy of categories (levels) that describe data in a fact table. These categories typically describe a similar set of members upon which the user wants to base an analysis. For example, a geography dimension might include levels for Country, Region, State or Province, and City.

The term “hierarchy” refers to a logical tree structure that organizes the members of a dimension such that each member has one parent member and zero or more child members.

The term “level” refers to the name of a set of members in a dimension hierarchy such that all members of the set are at the same distance from the root of the hierarchy. For example, a time hierarchy may contain the levels Year, Month, and Day.

The term “attribute” refers to a single aspect of a piece of data. For example, a color attribute, a size attribute, a style attribute and the like, may describe a product. Attributes may or may not be organized into hierarchies.

The term “measure” refers to values within a cube that are based on a column in the cube's fact table store and are usually numeric. Measures are the central values that are aggregated and analyzed.

The term “member” refers to an item in a dimension representing one or more occurrences of data. A member can be either unique or non-unique. For example, 1997 and 1998 represent unique members in the year level of a time dimension, whereas January represents non-unique members in the month level because there can be more than one January in the time dimension if the cube contains data for more than one year.

The term “OLAP” refers to Online Analytical Processing. OLAP is a technology that uses multidimensional structures to provide rapid access to data for analysis. The source data for OLAP is commonly stored in data warehouses in a relational database.

The term “tuple(s)” refers to an ordered collection of members from different dimensions. For example, ([Boston], [1995]) is a tuple formed by members of two dimensions: Geography and Time.

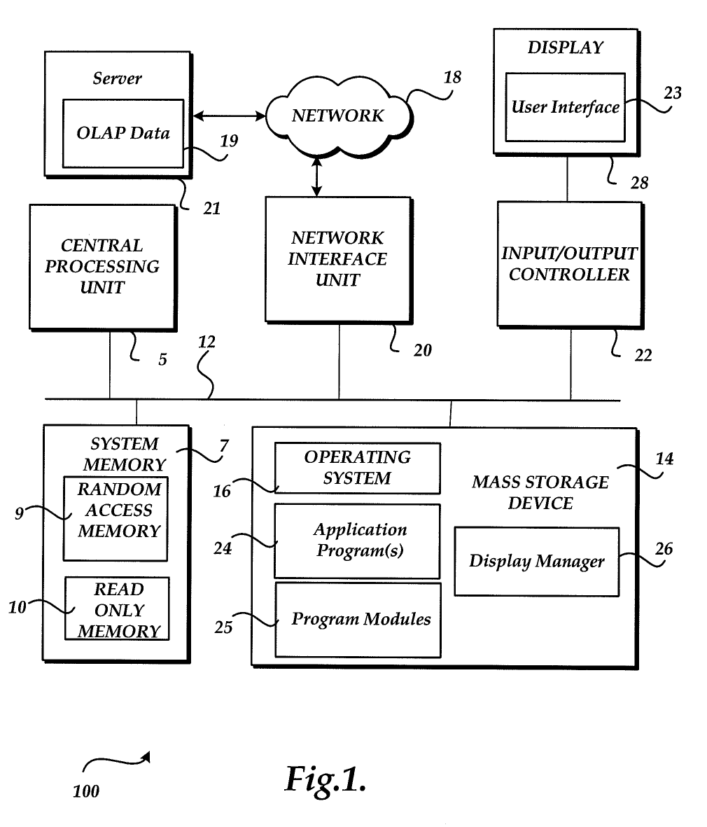

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application program(s) 24, other program modules 25, and display manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to a display 28, a printer, or other type of output device.

As mentioned briefly above, a number of program modules and data files may be stored in the mass storage device 14 and RAM 9 of the computer 100, including an operating system 16 suitable for controlling the operation of a computer, such as WINDOWS SERVER® or the WINDOWS VISTA® operating system from MICROSOFT CORPORATION of Redmond, Wash. The mass storage device 14 and RAM 9 may also store one or more program modules. In particular, the mass storage device 14 and the RAM 9 may store one or more application programs 24 and program modules 25. Application program 24 may be an application that is configured to interact with OLAP data, such as OLAP data that is stored on server 21. Generally, display manager 26 is configured to optimize the hierarchies of the OLAP data 19 such that navigation is simplified for a user. An OLAP navigation user interface 23 displays the hierarchies within the OLAP data that are navigable and can be drilled down into. In this way, a user is shown the items within the OLAP data that may be drilled down into instead of being shown every item in the OLAP data. When determining the items to display for navigation, any hierarchies with a single level and/or any attributes that also are used as levels are not shown within the user interface. This helps the user choose the displayed item that will have be most capabilities for OLAP interaction. Navigation of the OLAP data is also simplified for the user since the number of items displayed within user interface 23 is reduced. The operation of display manager 26 is described in more detail below.

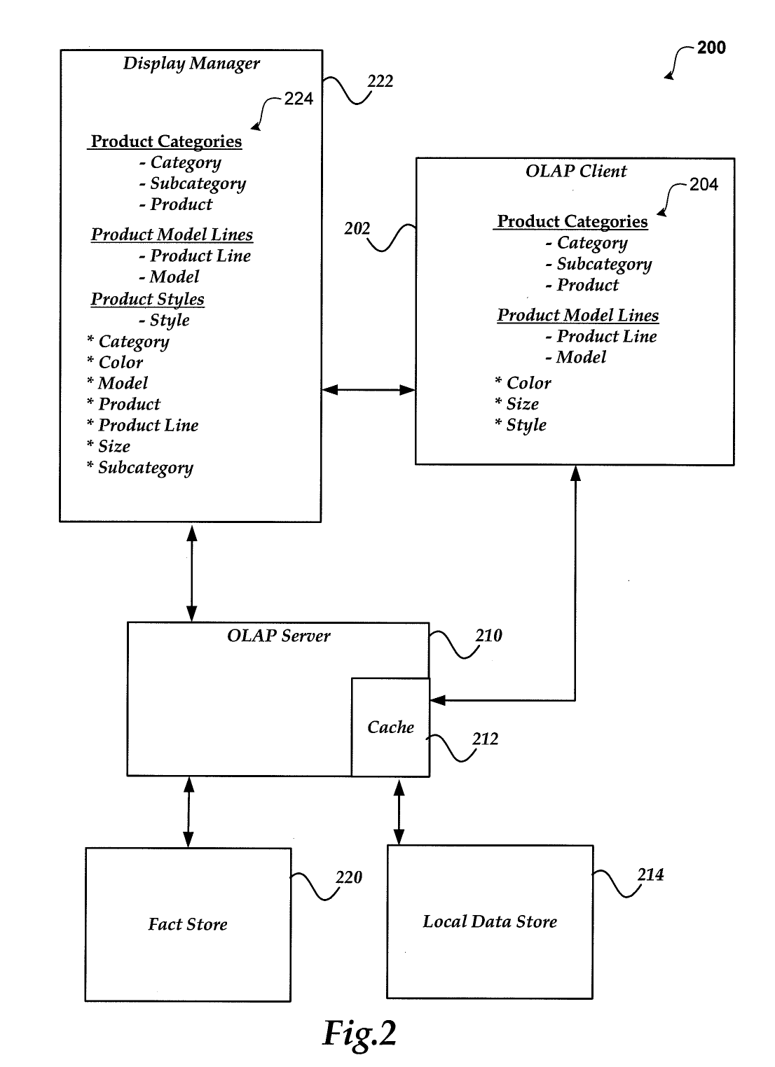

FIG. 2 illustrates an OLAP navigation system 200, in accordance with aspects of the present invention. As illustrated, the system includes OLAP client 202, display manager 222, OLAP server 210, local data store 214, and fact data store 220, all of which may interact with the data within an OLAP cube(s).

OLAP client 202 is an application program that uses the services of an OLAP system. OLAP client 202 may be any type of application that interacts with the OLAP system and queries an OLAP cube for data. For example, OLAP client 202 could be a program such as a ProClarity® product from Microsoft Corporation, a spreadsheet program, such as the Excel® spreadsheet program by Microsoft Corporation, or some other program. OLAP client 202 typically interacts with OLAP server 210 by issuing OLAP queries requesting data from a cube. These queries are parsed into a request for data from the cube, and the request is passed to the OLAP server 210. The data retrieved from the cube may be requested in response to a user interacting with a user interface that is associated with OLAP client 202. For example, a user may be navigating data within a cube.

OLAP server 210 receives the query and controls the processing of the query. In one embodiment of the invention, OLAP server 210 maintains a local data store 214 that contains the data used to answer queries. In one embodiment of the invention, the OLAP server 210 is a version of the PerformancePoint® Server product from Microsoft Corporation.

Local data store 214 contains records describing the cells that are present in a multidimensional database, with one record used for each cell that has measurement data present (i.e. no records exist for those cells having no measurement data). In an embodiment of the invention, local data store 214 is a relational database, such as SQL Server. In alternative embodiments of the invention, database systems such as Oracle, Informix or Sybase can be used. The invention is not limited to any particular type of relational database system.

OLAP server 210 populates local data store 214 by reading data from fact data store 220. Fact data store 220 is also a relational database system. In one embodiment of the invention, the system used is the SQL Server Database from Microsoft Corporation. In alternative embodiments of the invention, any type of relational database system may be used. For example, database systems such as Oracle, Informix or Sybase can be used.

According to one embodiment, records are stored in a relational table. This table can be indexed based on the dimensional paths of the record to allow rapid access to cell measurement data contained in the record.

In one embodiment of the invention, OLAP server 210 maintains a cache 212 of records. In this embodiment, cache 212 maintains data records that have been recently requested, or those data records that are frequently requested. Maintaining cell record data in a cache may help provide quicker responses to queries that can be satisfied by records appearing in the cache.

Display manager 222 is configured to optimize the hierarchical attributes that are displayed to a user using OLAP client 202. In the example illustrated, without optimization of the hierarchical attributes, display 224 would be shown in the user interface that is associated with OLAP client 202. As illustrated, this small display 224 contains three hierarchies (Product Categories, Product Model Lines and Product Styles) with a total of six levels (category, subcategory, product, product line, model and style). Display 224 also contains seven attributes (category, color, model, product, product line, size and subcategory) that describe each product. Without optimization by display manager 223, display 224 has several disadvantages for the user (especially when the cube data is large). For example, it is confusing to see Category listed two times (once as a level and once as an attribute). In this situation it is hard for the user to determine which category to choose in order to perform OLAP analysis. The user may choose the wrong category (i.e. the attribute in this example) an not be able to drill down into the category. Additionally, as can be seen even in this very small example, the list of items becomes lengthy quickly. Further, many items are shown twice and the user cannot see the true “attributes.” This is a very simple example, but in many common cases there may be 50 to 100 attributes further creating navigation problems for the user. In some cases, hierarchies and levels may act like attributes, but are shown as hierarchies. In the current example the third hierarchy shown in display 224, Product Style, acts like an attribute and can't be drilled down on since it only has one level.

Display manager 224 is configured to simplify OLAP navigation by optimizing the displayed hierarchies by displaying the hierarchies that are navigable and can be drilled down into and removing from the display the other hierarchies that can not be navigated. In this way, a user is shown the items within the OLAP data that may be drilled down into instead of being shown every item. When determining the items to display for navigation, display manager 222 determines any hierarchies with a single level and/or any attributes that also are used as levels are not shown within the user interface. This helps the user choose the displayed item that will have be most capabilities for OLAP interaction. In the current example, the third hierarchy in display 224 (product styles) is only one level and therefore is not displayed in display 204. Additionally, attributes that are duplicated within a level are also removed from display. In the current example, the attributes category, model, product, product line, and subcategory are removed from display 204. According to one embodiment, this determination is made by comparing the names of the levels with the names of the attributes. When the name of the attribute matches the name of the level, the attribute is removed from the optimized display. As can be seen, display 204 is much simpler to navigate. As illustrated, display 204 includes: two hierarchies, product categories and product model lines; five levels: category, subcategory, product, product line and model; and three attributes including color, size and style. Optimizing the display 204, assists the user choose the item that will have be most capabilities for OLAP interaction.

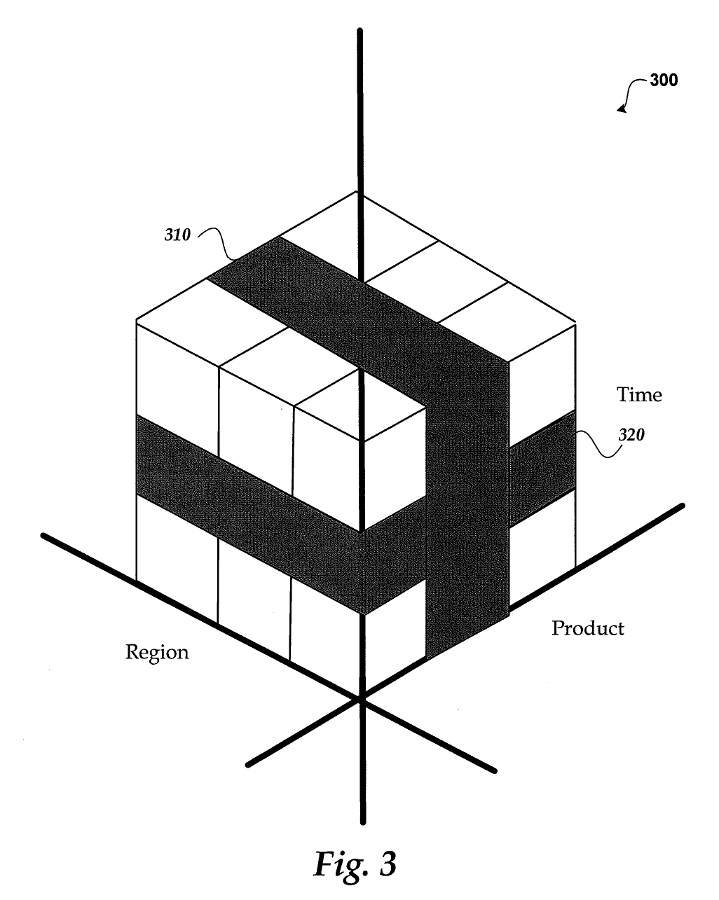

FIG. 3 illustrates an exemplary OLAP cube.

In an OLAP data model, information is viewed conceptually as cubes that consist of descriptive categories (dimensions) and quantitative values (measures). The multidimensional data model makes it easier for users to formulate complex queries, arrange data on a report, switch from summary to detail data, and filter or slice data into meaningful subsets. For example, typical dimensions in a cube containing sales information may include time, geography, product, channel, organization, and scenario (budget or actual). Typical measures may include dollar sales, unit sales, inventory, headcount, income, and expense.

Within each dimension of an OLAP data model, data can be organized into a hierarchy that represents levels of detail on the data. For example, within the time dimension, there may be levels for years, quarters, months, and days. Similarly, a geography dimension may include: country, region, state/province, and city levels. A particular instance of the OLAP data model would have the specific values for each level in the hierarchy. A user viewing OLAP data can move up or down between levels to view information that is either more or less detailed.

The cube is a specialized database that is optimized to combine, process, and summarize large amounts of data in order to provide answers to questions about that data in the shortest amount of time. This allows users to analyze, compare, and report on data in order to spot business trends, opportunities, and problems. A cube uses pre-aggregated data instead of aggregating the data at the time the user submits a query.

Hierarchies and levels can be defined for dimensions within the cube. Hierarchies typically display the same data in different formats such as time data can appear as months or quarters. Levels typically allow the data to be “rolled up” into increasing less detailed information such as in a Region dimension where cities roll-up into states which roll-up into regions which roll-up into counties and so forth. This allows the user to “drill-up” or “drill-down” to see the data in the desired detail. Levels and hierarchies for a star schema are derived from the columns in a dimension table. In a snowflake schema, they are typically derived from the data in related tables.

The exemplary OLAP cube illustrated includes three dimensions. The Region dimension may many different levels. For example, the region dimension may include a country level, a geographic area level (NE, NW, SE, SW, and the like), and a city level. The Products dimension may also include multiple levels. For example, has all, category and product. Finally, the third dimension, the Time dimension may include multiple levels, such as year, quarter, and month). The cube may also include multiple measures. For example, unit sales and purchases. This cube is presented to provide a reference example of how a cube is used. It will be appreciated that the OLAP cubes maintained by various embodiments of the invention may have more or fewer dimensions than in this example, and that the OLAP cube may have more or fewer hierarchy levels than in this exemplary example.

Each data cell in a multidimensional database is uniquely identified by specifying a coordinate on each dimension. In order to uniquely identify a particular member within the OLAP cube, each of the members from the root node to the leaf node for the member is specified forming a tuple. A tuple may contain one or more members. According to one embodiment, each tuple contains the same number of members to access the desired data within the cube.

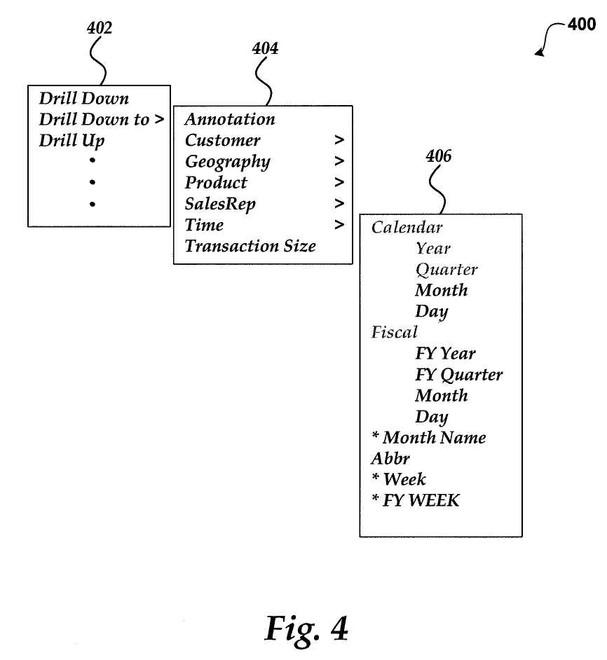

FIG. 4 shows an exemplary menu system for navigating OLAP data. As shown, menu system 400 includes three drop down menus (402, 404 and 406).

Generally, a user can navigate OLAP data by drilling down, cross drilling and drilling up. Drill Up replaces all the members in the segment with the parent of the selected member, along with all its siblings. Drill Down replaces all the members in the segment with the children of the selected member. Cross drilling drills down further into a slice of the cube while maintaining a selected hierarchy. In the example shown in FIG. 4, the user selects the drill down to option in menu 402 which displays menu 404 which shows the user with the available options to select. As discussed above, when there is only one hierarchy and one level to drill into, then a submenu is not displayed within menu 404. When there is more than one level then the user is shown the hierarchy and the user may select the submenu. In the current example, the user has selected the time level in menu 404 which displays the selectable hierarchies in menu 406. According to one embodiment, the attributes that are not list in the user-defined hierarchy are shown at the end of the menu. Other arrangements of the items displayed may also be used.

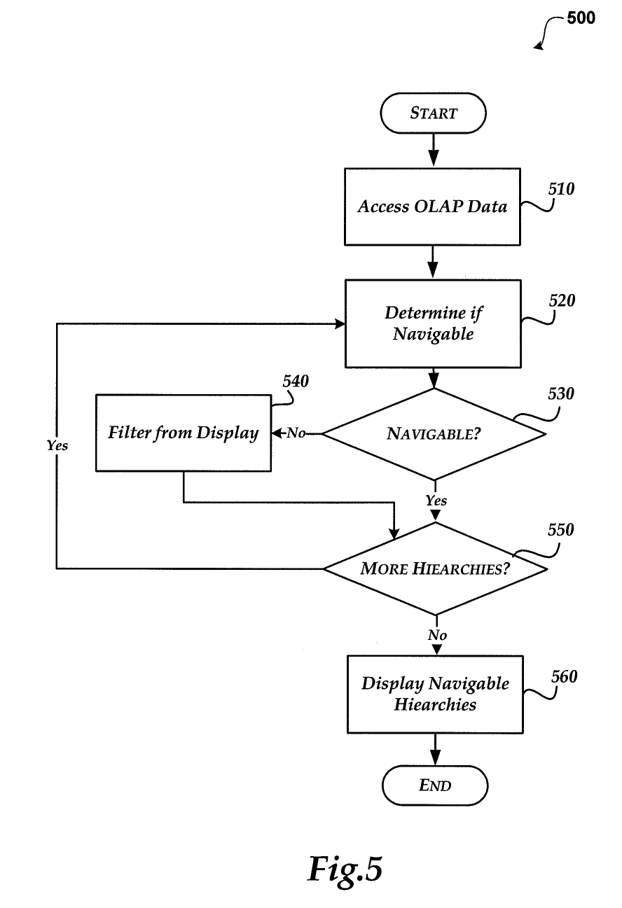

Referring now to FIG. 5, an illustrative process 500 for optimizing the displayed hierarchies for navigation will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 510, where the OLAP data is accessed.

Moving to operation 520, a determination is made as to whether the hierarchy is navigable. When determining the items to display for navigation, display manager 222 determines any hierarchies with a single level and/or any attributes that also are used as levels are not shown within the user interface. According to one embodiment, attributes having the same name as a level processed are removed. This determination is made by comparing the names of the levels with the names of the attributes. When the name of the attribute matches the name of the level, the attribute is filtered from the optimized display.

Moving to decision operation 530, when the hierarchy is not navigable the process moves to operation 540, where the hierarchy is filtered from display. In this way, a user is shown the items within the OLAP data that may be drilled down into instead of being shown every item. When the hierarchy is navigable, the process moves to operation 550 where a determination is made as to whether there are more hierarchies to process. When there are more hierarchies, the process returns to operation 520. When there are not more hierarchies to process, the process moves to operation 560 where the navigable hierarchies are displayed. The process then moves to an end operation.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for displaying OLAP data for navigation, comprising:
accessing a cube having hierarchies including dimensions, levels, and attributes that is associated with an OLAP service;
determining hierarchies within the cube that are navigable;
filtering the non-navigable hierarchies; and
displaying the navigable hierarchies.

2. The method of claim 1, wherein determining the hierarchies within the cube that are navigable comprises determining when the hierarchies that are more than one level deep.

3. The method of claim 1, wherein displaying the navigable hierarchies comprises displaying a navigation menu that includes an option to drill down within the cube; wherein the navigation menu displays the navigable hierarchies of the cube and filters the non-navigable hierarchies.

4. The method of claim 1, wherein determining the hierarchies within the cube that are navigable comprises filtering repeated hierarchies.

5. The method of claim 4, wherein filtering repeated hierarchies comprises determining when an attribute has a same name as another hierarchy within the cube.

6. The method of claim 1, wherein determining the hierarchies within the cube that are navigable comprises determining when a dimension of the cube acts as an attribute.

7. The method of claim 1, further comprising examining metadata that is associated with each the hierarchies in determining the hierarchies within the cube that are navigable.

8. The method of claim 5, further comprising, accessing each hierarchy within the cube and storing a name for each hierarchy that is used in the comparison.

9. A computer-readable storage medium having computer-executable instructions for displaying OLAP data for navigation, comprising:
accessing at least a portion of OLAP data having hierarchies including dimensions, levels, and attributes;
determining portions of the hierarchies of the OLAP data to display by determining hierarchies within the cube that are navigable based on a number of levels that is associated with each of the hierarchies;
filtering the non-navigable hierarchies; and
displaying the navigable hierarchies.

10. The computer-readable storage medium of claim 9, wherein determining the hierarchies within the cube that are navigable comprises determining when the number of hierarchies for each of hierarchy are more than one level deep.

11. The computer-readable storage medium of claim 9, wherein displaying the navigable hierarchies comprises displaying a navigation menu that includes an option to drill down within the OLAP data; wherein the navigation menu displays the navigable hierarchies of the OLAP data and filters the non-navigable hierarchies from view.

12. The computer-readable storage medium of claim 9, wherein determining the hierarchies within the cube that are navigable comprises determining hierarchies that are repeated in the OLAP data and filtering the repeated hierarchies.

13. The computer-readable storage medium of claim 12, wherein filtering the repeated hierarchies comprises determining when an attribute within the OLAP data has a same name as another hierarchy within the OLAP data.

14. The computer-readable storage medium of claim 9, wherein determining the hierarchies within the cube that are navigable comprises determining when a hierarchy of the OLAP data acts as an attribute.

15. The computer-readable storage medium of claim 13, further comprising, storing a name for each hierarchy that is used in the comparison of the attribute with the other hierarchies.

16. A system for displaying OLAP data for navigation, comprising:
a display;
a data store that is configured to OLAP data that includes hierarchies including dimensions, levels, and attributes;
a network connection that is configured to connect to the IP network;
a processor and a computer-readable medium;
an operating environment stored on the computer-readable medium and executing on the processor; and
a display manager operating under the control of the operating environment and operative to:
accessing the OLAP data;
determining the hierarchies of the OLAP data to display by determining hierarchies within the cube that are navigable;
filtering the non-navigable hierarchies; and
displaying the navigable hierarchies on the display.

17. The system of claim 16, wherein determining the hierarchies within the cube that are navigable comprises determining when the hierarchies for each of hierarchy are more than one level deep.

18. The system of claim 16, wherein displaying the navigable hierarchies comprises displaying a navigation menu that includes an option to drill down, drill up, and cross-drill within the OLAP data; wherein the navigation menu displays the navigable hierarchies of the OLAP data and filters the non-navigable hierarchies from view.

19. The system of claim 16, wherein determining the hierarchies within the cube that are navigable comprises determining hierarchies that are repeated in the OLAP data and filtering the repeated hierarchies.

20. The system of claim 19, wherein filtering the repeated hierarchies comprises determining when an attribute within the OLAP data has a same name as another hierarchy within the OLAP data.
